(19) United States
(12) Patent Application Publication
(10) Pub. No.: US 2025/0320960 A1
(43) Pub. Date: Oct. 16, 2025

(54) SMART BRACKET SYSTEM FOR WALL MOUNTED FLAT PANEL DISPLAYS

(71) Applicant: JBLM HOLDING GROUP, LLC, Phoenix, AZ (US)

(72) Inventor: Bao Thai, Phoenix, AZ (US)

(73) Assignee: JBLM HOLDING GROUP, LLC, Phoenix, AZ (US)

(21) Appl. No.: 19/175,561

(22) Filed: Apr. 10, 2025

Related U.S. Application Data
(60) Provisional application No. 63/632,111, filed on Apr. 10, 2024.

(51) Int. Cl. F16M 13/02; G06F 1/16

(52) U.S. Cl. CPC F16M 13/02; G06F 1/1601

(57) ABSTRACT

A smart bracket system for wall mounted flat panel displays may comprise a primary enclosure assembly having a removable faceplate, a rectilinear housing body with a contiguous sidewall and an end wall defining an interior volume of the primary enclosure assembly, a channel proximate the end wall and extending into the width of the housing body relatively upward from a lower sidewall toward an upper sidewall of the housing body of the primary enclosure assembly, and a mounting foot portion having a first recessed socket portion and a second recessed socket portion, a secondary enclosure assembly, a rectilinear protective panel, and a plurality of wall bracket assemblies.

### CROSS REFERENCE TO RELATED APPLICATIONS

This application claims priority to, and benefit of, U.S. Provisional Application No. 63/632,111 entitled “SMART BRACKET SYSTEM FOR FLAT PANEL SCREEN PROTECTOR” which was filed on Apr. 10, 2024. All of the contents of the previously identified application are hereby incorporated by reference for any purpose in their entirety.

### FIELD

The present disclosure relates generally to screen protective devices, and more particularly to screen guard assemblies for protecting electronic displays.

### BACKGROUND

With the development of the information society, various demands for flat panel display devices have been increasing. Various display devices, such as liquid crystal displays (LCDs), plasma display panels (PDPs), electroluminescent displays (ELDs), vacuum fluorescent displays (VFDs), light emitting diode displays (LEDs) and organic light-emitting diode displays (OLEDs) have been recently studied and used to meet various demands for the display devices. A great majority of the increasingly popular flat-screen monitors and flat-screen televisions based on these display types have substantially fragile screens that need to be protected from accidental damage. In addition to the propensity of the screen being damaged, a screen protective device may benefit a viewer by reducing glare and radiation emitted by the screen.

### SUMMARY

In various embodiments, systems, methods, and articles of manufacture (collectively, the “system”) for smart bracket assemblies are disclosed. A smart bracket system for wall mounted flat panel displays may comprise, a primary enclosure assembly having a removable faceplate, a rectilinear housing body with a contiguous sidewall and an end wall defining an interior volume of the primary enclosure assembly, a channel proximate the end wall and extending into the width of the housing body relatively upward from a lower sidewall toward an upper sidewall of the housing body of the primary enclosure assembly, and a mounting foot portion having a first recessed socket portion and a second recessed socket portion, a secondary enclosure assembly having a removable faceplate, a rectilinear housing body with a contiguous sidewall and an end wall defining an interior volume of the secondary enclosure assembly, a channel proximate the end wall and extending into the width of the housing body relatively downward from an upper sidewall toward a lower sidewall of the housing body of the secondary enclosure assembly, and a mounting foot portion having a third recessed socket portion, a rectilinear protective panel having a first longitudinal coupling feature and a second longitudinal coupling feature, wherein the first longitudinal coupling feature and the second longitudinal coupling feature are located proximate opposite edges of the protective panel, and a plurality of wall bracket assemblies, wherein each of the plurality of wall bracket assemblies comprises a wall interface plate, an enclosure interface plate, and a standoff plate coupled between the wall interface plate and the enclosure interface plate.

In various embodiments, a portion of the sidewall of the primary enclosure assembly comprises an orderly row of a plurality of perforations through the sidewall and into the interior volume of the housing body of the primary enclosure assembly enabling fluid communication therebetween. In various embodiments, a mounting face of the mounting foot portion of the primary enclosure assembly includes a wiring cutout. In various embodiments, the protective panel is slidably engageable with the channel in the housing body of the primary enclosure assembly and the channel of the housing body of the secondary enclosure assembly.

In various embodiments, the long axis of the enclosure interface plate and the long axis of the wall interface plate are disposed orthogonally to each other when viewed along the long axis of the of the standoff plate. In various embodiments, each of the first recessed socket portion and the second recessed socket portion comprises a socket face, and wherein a portion of an upper edge of each of the first recessed socket portion and the second recessed socket portion of the primary enclosure assembly is undercut along the plane of the respective socket face to form a corresponding groove. In various embodiments, each enclosure interface plate comprises a tab extending relatively outward of an upper edge of the enclosure interface plate and configured to interface with the groove of the first recessed socket portion and the groove of the second recessed socket portion.

In various embodiments, at least one electronic component is disposed within the interior volume of the primary housing assembly. In various embodiments, the primary enclosure assembly includes a DIN rail within the interior volume, and wherein the at least one electronic component is coupled to the DIN rail.

In various embodiments, a flat panel display protection kit for a wall mounted flat panel display is provided comprising a primary enclosure assembly having a removable faceplate, a rectilinear housing body with a contiguous sidewall and an end wall defining an interior volume of the primary enclosure assembly, a channel proximate the end wall and extending into the width of the housing body relatively upward from a lower sidewall toward an upper sidewall of the housing body of the primary enclosure assembly, and a mounting foot portion having a first recessed socket portion and a second recessed socket portion, at least one secondary enclosure assembly, wherein each secondary enclosure assembly has a removable faceplate, a rectilinear housing body with a contiguous sidewall and an end wall defining an interior volume of the secondary enclosure assembly, a channel proximate the end wall and extending into the width of the housing body relatively downward from an upper sidewall toward a lower sidewall of the housing body of the secondary enclosure assembly, and a mounting foot portion having a third recessed socket portion, a plurality of wall bracket assemblies, wherein each of the wall bracket assemblies comprises a wall interface plate, an enclosure interface plate, and a standoff plate coupled between the wall interface plate and the enclosure interface plate, and a rectilinear protective panel having a first longitudinal coupling feature and a second longitudinal coupling feature, wherein the first longitudinal coupling feature and the second longitudinal coupling feature are located proximate opposite edges of the protective panel, said kit being in a useful configuration wherein the primary enclosure assembly is coupled to the wall and proximate the wall mounted flat panel display, wherein the primary enclosure assembly is coupled to the wall via at least one of the plurality of wall bracket assemblies at the first recessed socket portion and at least one of the plurality of wall bracket assemblies at the recessed socket portion, and each of the at least one secondary enclosure assembly are coupled at their respective third recessed socket portion, via at least one of the plurality of wall bracket assemblies, to the wall and proximate the wall mounted flat panel display, and wherein the rectilinear protective panel is inserted into and coupled within the channel of the housing body of the primary enclosure assembly and the channel of the housing body of each secondary enclosure assembly, thereby disposing the wall mounted flat panel display relatively between the protective panel and the wall.

In various embodiments, the plurality of wall bracket assemblies comprises at least four wall bracket assemblies and wherein the at least one secondary enclosure assembly comprises at least two secondary enclosure assemblies. In various embodiments, the kit further comprises a plurality of fasteners. In various embodiments, the kit further comprises a set of assembly instructions.

In various embodiments, wherein a portion of the sidewall of the primary enclosure assembly comprises an orderly row of a plurality of perforations through the sidewall and into the interior volume of the housing body of the primary enclosure assembly enabling fluid communication therebetween. In various embodiments, a mounting face of the mounting foot portion of the primary enclosure assembly includes a wiring cutout. In various embodiments, the kit further comprises at least one electronic component disposed within the interior volume of the primary housing assembly. In various embodiments, the housing body of the primary enclosure assembly has a length to width ratio of between 3:1 and 14:1. In various embodiments, the housing body of each of the at least one secondary enclosure assembly has a length to width ratio of between 1:1 and 4:1.

The foregoing features and elements may be combined in various combinations without exclusivity, unless expressly indicated herein otherwise. These features and elements as well as the operation of the disclosed embodiments will become more apparent in light of the following description and accompanying drawings

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1A illustrates a smart bracket system, in accordance with various exemplary embodiments;

FIG. 1B illustrates a smart bracket system, in accordance with various exemplary embodiments;

FIG. 2 illustrates a primary enclosure assembly of a smart bracket system, in accordance with various exemplary embodiments;

FIG. 3 is illustrates the primary enclosure assembly, in accordance with various exemplary embodiments;

FIG. 4 illustrates a mounting foot portion and a channel of the primary enclosure assembly, in accordance with various exemplary embodiments;

FIG. 5 illustrates a mounting face of the primary enclosure, in accordance with various exemplary embodiments;

FIG. 6 illustrates a mounting face of the primary enclosure, in accordance with various exemplary embodiments;

FIG. 7 illustrates electronic components of the system, in accordance with various exemplary embodiments;

FIG. 8 illustrates a secondary enclosure assembly, in accordance with various exemplary embodiments;

FIG. 9 illustrates a mounting foot portion of a secondary enclosure assembly, in accordance with various exemplary embodiments;

FIG. 10 illustrates a mounting face, in accordance with various exemplary embodiments;

FIG. 11 illustrate a recessed socket portion, in accordance with various exemplary embodiments;

FIG. 12 illustrates electronic components of the system, in accordance with various embodiments;

FIG. 13 illustrates electronic components of the system, in accordance with various embodiments;

FIG. 14 illustrates a wall bracket assembly, in accordance with various embodiments;

FIG. 15 illustrates a wall interface plate, in accordance with various embodiments;

FIG. 16 illustrates a standoff plate, in accordance with various embodiments; and

FIG. 17 illustrates an enclosure interface plate, in accordance with various exemplary embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments in addition to providing mechanical protection for the display device, the system includes one or more sensors and may communicate electronically with the display device or with a computer network. Prior systems were purely mechanical and featured no electronic interface with the protected display device or any computer network. The present system improves over these prior systems by enabling electronic communication between the one or more sensors and the display device and/or network. In this regard, the system may be said to be a ‘smart device’. For example, by enabling capture and processing of sensor inputs, the system may acquire feedback about the user of the display device and/or about various individuals, features, or conditions etc. within the detection range of the sensing devices. The system may process the data and return the processed data to the display device and, in this regard, may tend to enhance the functionality of the display device.

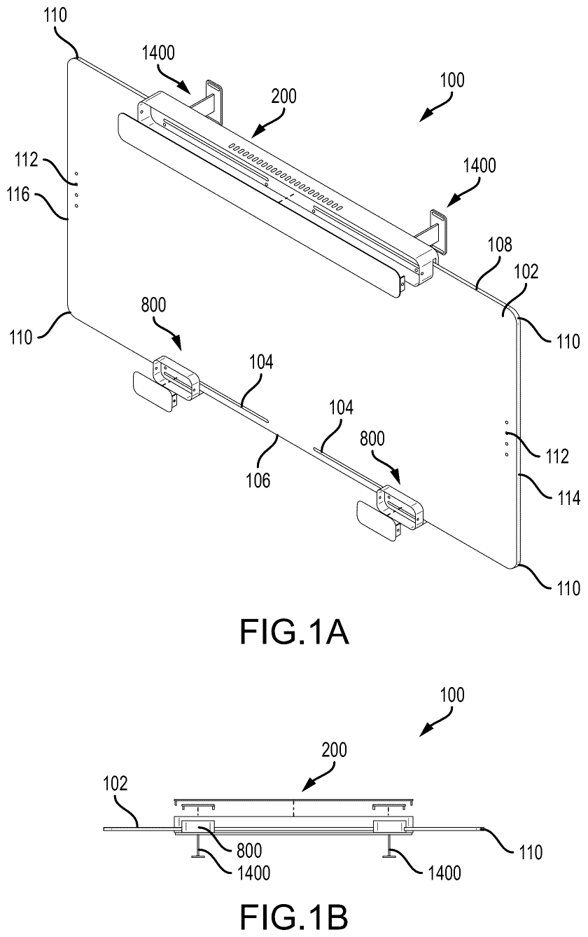

In various embodiments and with reference to FIGS. 1A and 1B, a smart bracket system 100 is illustrated as assembled and mounted to a wall. FIG. 1A illustrates smart bracket system 100 in a partially exploded perspective view. FIG. 1B illustrates smart bracket system 100 in a top down view. In various embodiments, smart bracket system 100 may comprise a primary enclosure assembly 200, one or more secondary enclosure assemblies 300, one or more wall bracket assemblies 1400, and a protective panel 102. A flat panel display (not shown) may be disposed between the wall and the protective panel 102, thereby providing mechanical protection to the flat panel display such as, for example, in the event of objects impacting with the protective panel 102. Protective panel 102 includes one or more longitudinal coupling features 104 proximate a first edge 106 of the panel 102. In various embodiments, the longitudinal coupling features 104 are included proximate both the first edge 106 and a second edge 108 opposite the first edge 106. The longitudinal coupling features 104 may comprise a channel extending parallel to the respective edge and through the full thickness of the panel 102 material. In panel 102 may be relatively rectilinear and comprise rounded corners 110. In various embodiments, panel 102 may include one or more rows of perforations 112 proximate to a third edge 114 of the panel. In various embodiments, the rows of perforations 112 are included proximate both the third edge 114 of the panel 102 and a fourth edge 116 opposite the third edge 114. The rows of perforations 112 extend parallel to the respective edge. In various embodiments, first edge 106 and second edge 108 may be the long edges of the panel 102 with third edge 114 and fourth edge 116 the short edges of the panel 102.

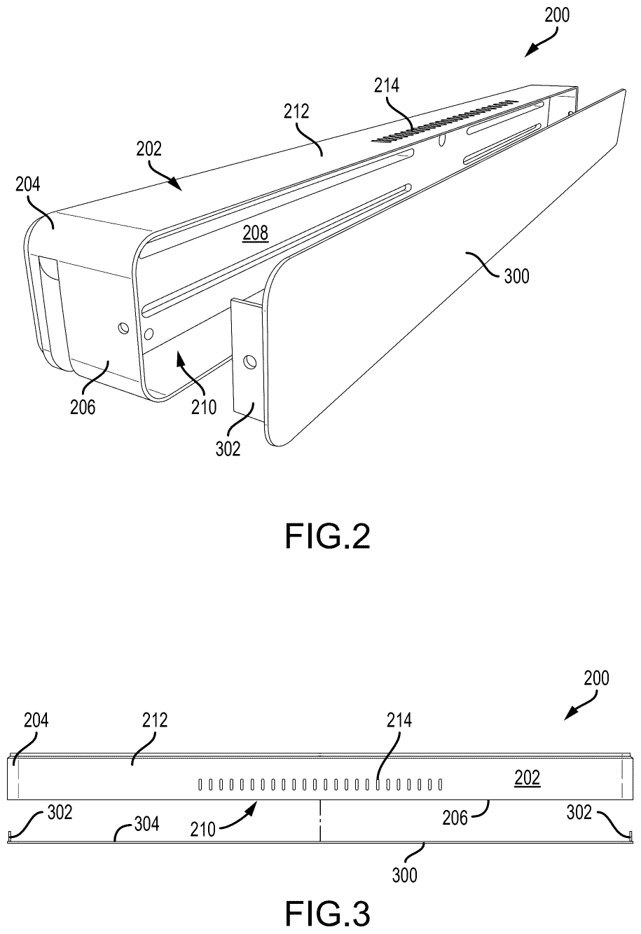

In various embodiments and with combined reference to FIGS. 2 and 3, the primary enclosure assembly 200 is illustrated. FIG. 2 illustrates the primary enclosure assembly 200 in perspective view. FIG. 3 illustrates the primary enclosure assembly 200 in a top down view. In various embodiments, the primary enclosure assembly 200 may comprise a housing having a rectilinear body (i.e. housing body 202). The housing body 202 may have filleted corners 204. The primary enclosure assembly housing body 202 may have a length to width ratio of between 3:1 and 14:1, or between 3:1 and 12:1, or between 3:1 and 10:1, or between 3:1 and 8:1, or between 5:1 and 10:1.

In various embodiments, a contiguous sidewall 206 and an interior end wall 208 of the housing body 202 define an interior volume 210 within the housing body 202. The interior volume 210 of housing body 202 may be enclosed by a faceplate 300. In various embodiments, faceplate 300 includes faceplate brackets 302 extending orthogonally from an interior face 304 of the faceplate 300. In various embodiments, in response to coupling the faceplate 300 to the housing body 202, the faceplate brackets 302 are disposed within the interior volume 210 and contacted with an interior surface of the sidewall 206. In various embodiments, a portion of the sidewall 206 such as, for example, the upper sidewall 212 may comprise an orderly row of a plurality of perforations 214 through the thickness of the sidewall into the interior volume 210 of the housing body 202. In this regard, the interior volume 210 of the housing body 202 may be fluidly coupled to the environment exterior of the housing body 202 to facilitate convective heat exchange. In various embodiments, each of the plurality of perforations 214 may be rectilinear with the long axis of each of the plurality of perforations 214 orthogonal to the long axis of the housing body 202.

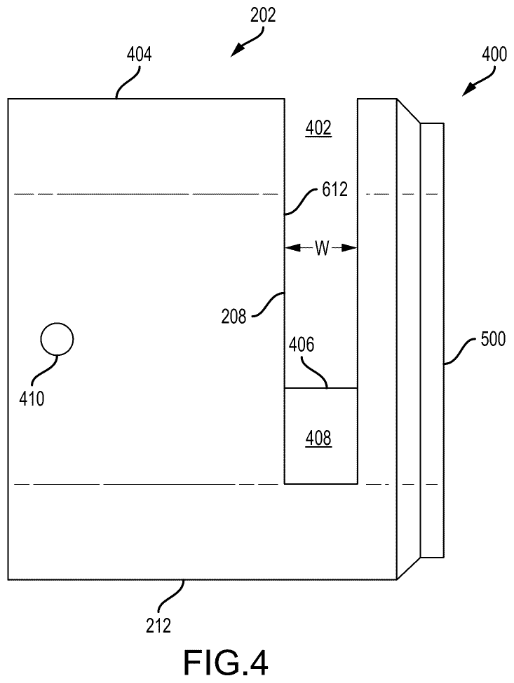

In various embodiments and with additional reference to FIG. 4, a mounting foot portion 400 of the housing body 202 is illustrated. Mounting foot portion 400 may be defined by a channel 402 cut relatively into the lower sidewall 404 of the housing body 202. The channel 402 may extend along the full length of the housing body 202 and be proximate the interior end wall 208 of the housing. The mounting foot portion 400 is proximate the channel 402 and, in this regard, the width ‘W’ of the channel 402 is defined between the interior end wall 208 of the housing body 202 and the mounting foot portion 400.

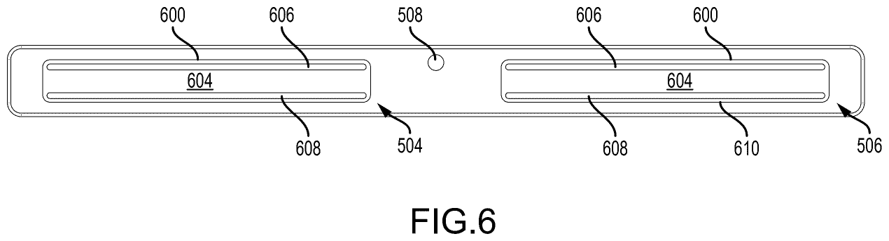

In various embodiments, the channel 402 is sized to slip over an edge (for example, second edge 108) of the protective panel 102 so that a portion of the edge of the protective panel is enclosed within the channel 402. The channel 402 extends into the width of the housing body 202 from the lower sidewall 404 of the housing body 202 relatively upward toward the upper sidewall 212 with the base 406 of the channel 402 disposed between one half and two thirds of the distance between the lower sidewall 404 to the upper sidewall 212. In various embodiments, the ends of the channel base 406 curve inward from the sidewall 206. In this regard, the curved ends 408 of the channel may tend to facilitate case of mechanical interface with the protective panel 102 by slidably engaging with the protective panel 102 edge (e.g., second edge 108) to direct the panel edge into the channel 402 and align longitudinal coupling features 104 with the second mounting feature 608 (shown in FIG. 6). In various embodiments, the sidewall 206 may include a coupling feature 410 to facilitate coupling the faceplate 300 to the housing body 202. In various embodiments, the coupling feature 410 may include a locking mechanism to secure the faceplate 300 to the housing body 202.

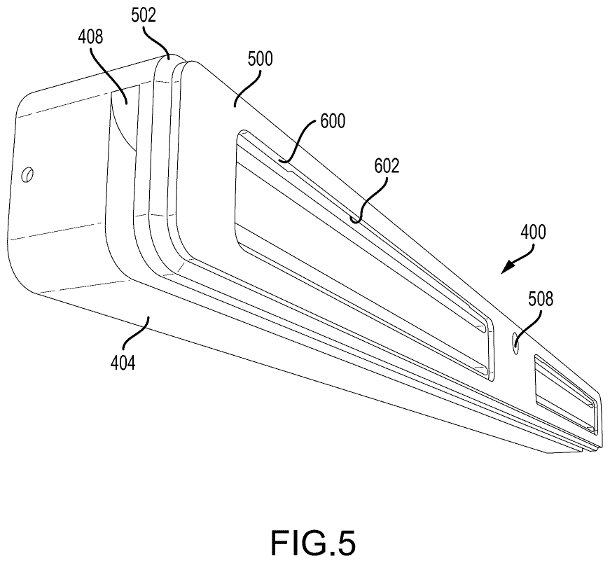

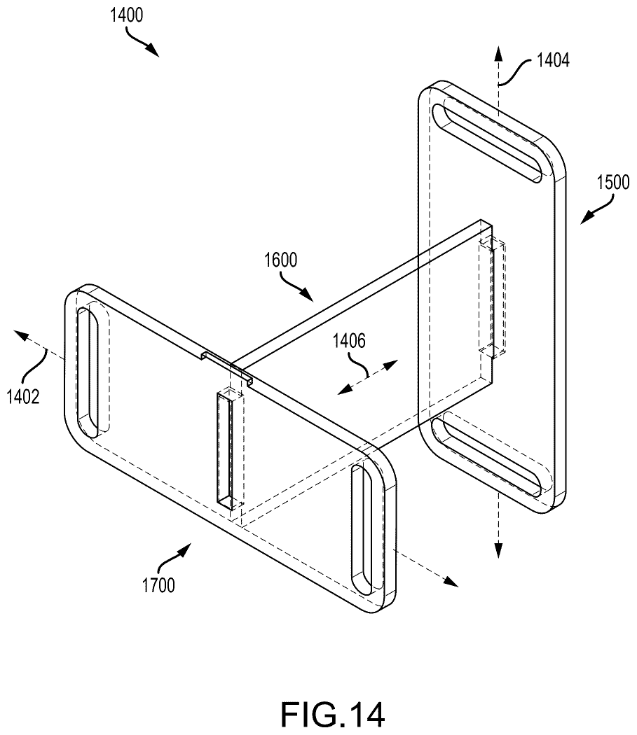

In various embodiments and with reference to FIGS. 5 and 6, the mounting foot portion 400 defines a mounting face 500. The mounting face 500 is distal of the channel 402 and interior end wall 208, and, when the interior volume 210 is enclosed, distal of the faceplate 300. In various embodiments, the mounting face 500 may be rebated from the outer diameter of the mounting foot portion via a rebating feature 502 such as a chamfer, fillet, or step. The mounting face 500 comprises a first recessed socket portion 504 and a second recessed socket portion 506. Each of the recessed socket portions (504, 506) comprise a socket face 604 and are configured to interface with the wall bracket assembly described further herein. In various embodiments, a portion of the upper edge 600 of each of the recessed socket portions (504, 506) is undercut along the plane of the respective socket face 604 to form a groove 602. In this regard, the groove 602 extends relatively upward from the upper edge 600 into the mounting foot portion 400. The groove 602 is configured to retain a tab 1718 of the wall bracket assembly 1400 described below in FIGS. 14-17. In response to inserting the tab 1718 of the wall bracket assembly 1400 into the corresponding groove of the recessed socket portion, an interference is generated which inhibits axial or vertical separation of the wall bracket assembly 1400 from the primary enclosure 200 but enables lateral translation of the primary enclosure 200 with respect to the wall bracket assembly 1400 (i.e., the wall bracket assembly may slidably engaged at the socket face 604 such that the wall bracket assembly slides at the socket face 604 along the long axis of the primary enclosure 200).

In various embodiments, a first mounting feature 606 and a second mounting feature 608 are formed into the socket face 604. The first mounting feature 606 may comprise a longitudinal slot cut into the socket face 604 proximate the upper edge 600. The first mounting feature 606 may extend through the full thickness of the mounting foot portion 400 and directly through the interior end wall 208 into the interior volume 210 of the housing body 202.

The second mounting feature 608 may comprise a longitudinal slot cut into the socket face 604 proximate the lower edge 610 of the respective recessed socket portion (504, 506). The second mounting feature 608 is cut through the full thickness of the mounting foot portion 400 and opens into the channel 402. The cut of the second mounting feature 608 is continued through the channel 402 (i.e., across the width W of the channel 402 gap) to a matching cutout 612 (see FIG. 4) through the interior end wall 208 and into the interior volume 210 of the housing body 202. In various embodiments, in response to inserting the second edge 108 of the protective panel 102 into the channel 402, a longitudinal coupling feature 104 proximate the second edge 108 is aligned with the matching cutout 612 and the second mounting feature 608.

In various embodiments the mounting face 500 includes a wiring cutout 508. The wiring cutout 508 extends through the mounting face 500 and directly into the interior volume 210 of the housing body 202. In various embodiments, the wiring cutout 508 may be positioned proximate the upper sidewall 212 and between the first recessed socket portion 504 and the second recessed socket portion 506.

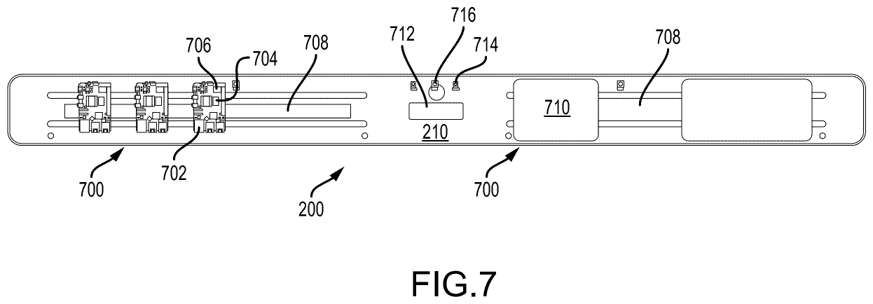

In various embodiments and with reference to FIG. 7 the primary enclosure assembly 200 is illustrated with the faceplate 300 rendered transparent and viewing directly into the interior volume 210 of the housing body 202. A plurality of electronic system components 700 may be mounted within the primary enclosure. For example, the electronic system components 700 may comprise systems including a processor 702, a tangible non-transitory computer-readable memory 704, and/or a network interface 706, along with other suitable system software and hardware components. Instructions stored on the tangible non-transitory memory may allow system to perform various functions, as described herein.

In various embodiments, the system components 700 may include one or more sensors and system/software modules 710 such as, for example, uninterruptable power supplies, Ultra Wide-Band sensors for real-time location sensing, NFC sensors, cameras and camera modules, AI face recognition and tracking modules, skeleton/hand tracking modules, 3D object pose estimation modules, computer vision modules, edge detection and/or 3D feature tracking modules, heart-rate estimation and monitoring modules, neural network on chip modules (e.g., for object recognition, semantic segmentation, landmark detection, etc.), AI event processing modules (i.e., in the context of observing players of a sporting event configured for score keeping, hit, stats, speed, player location, fall detection, etc.), AI motion estimation modules, OSI layer 2 or layer 3 switching modules, power over ethernet modules, smart power strips (e.g. configured for automatic recovery or management of system devices and modules, having AC power outlets with remote monitoring and restart, integrated circuit breakers and surge protectors, etc.), image sensors configured for gesture tracking and motion tracking, HDMI video output modules, temperature sensors configured for monitoring the components 700, video encoding modules, active cooling modules (e.g., including fans and heat sinks which may be controlled by temperature feedback), real-time memory usage monitoring modules, real-time processor usage monitoring modules, inductive RFID card readers, GPS modules, cellular (e.g. 4G/5G) communication modules, gyroscopes, real-time clock modules, IR sensors, microphones, LED controllers, RAID controller modules, UX/UI modules for touch screens, hard drives, ethernet controllers, Bluetooth modules, touch screen displays, buttons, controls, and or the like.

In various embodiments, the primary enclosure assembly 200 may include DIN rail 708 within the interior volume 210 (e.g., at the interior end wall 208 and/or on the interior face of the face plate 300) to facilitate the mechanical coupling of the various electronic components 700. In various embodiments electronic components such as, displays 712, buttons or other user controls 714, cameras and sensors 716 and/or the like may be mounted to and/or form a part of the faceplate 300. The face plate may include cutouts or other mechanical interfaces to facilitate visualization and/or user interaction with the aforesaid components or such components may be front mounted to the faceplate 300. In various embodiments, the entirety of a faceplate (such as faceplate 300 or faceplate 812) may comprise a touch screen display or other display. The electronic systems may include various computing devices, software modules, networks, and data structures in communication with one another. Electronic systems may also contemplate uses in association with web services, utility computing, pervasive and individualized computing, security and identity solutions, autonomic computing, cloud computing, commodity computing, mobility and wireless solutions, open source, biometrics, grid computing and/or mesh computing. Any of these components may be outsourced and/or be in communication with one another via a network. In various embodiments, the electronic systems may communicate with a user device or display device (for example, a display device mounted behind the protective panel). The user device may include, for example, a desktop computer, laptop computer, personal digital assistant, smart phone, mobile device, and/or the like and may allow a user to transmit requests to the electronic systems.

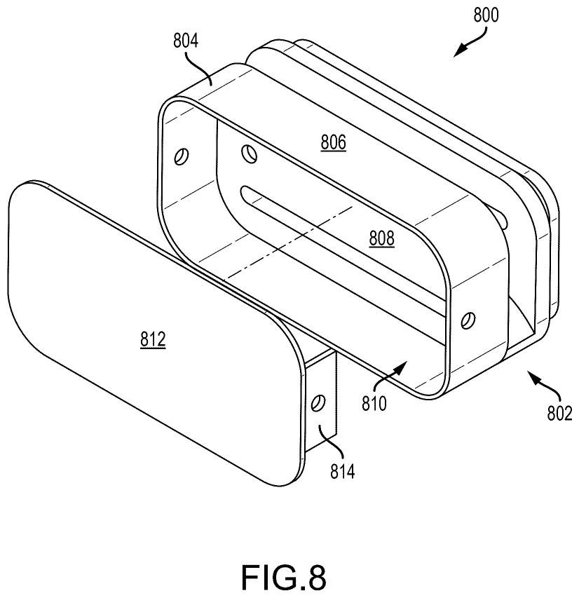

In various embodiments and with additional reference to FIG. 8, a secondary enclosure assembly 800 of smart bracket system 100 is illustrated in perspective view. The secondary enclosure assembly 800 may comprise various features and materials similar to those of the primary enclosure assembly 200. The secondary enclosure assembly 800 may comprise a housing having a rectilinear body (i.e. housing body 802). The housing body 802 may have filleted corners 804. In various embodiments, the secondary enclosure assembly 800 housing body 802 may have a length to width ratio of between 1:1 and 4:1, or between 1:1 and 3:1, or between 2:1 and 3:1. Secondary enclosure assembly 800 differs from the primary enclosure assembly 200 in that the ratio of the axial length of the secondary enclosure assembly 800 to that of the primary enclosure assembly 200 may be between 12:1 and 3:1.

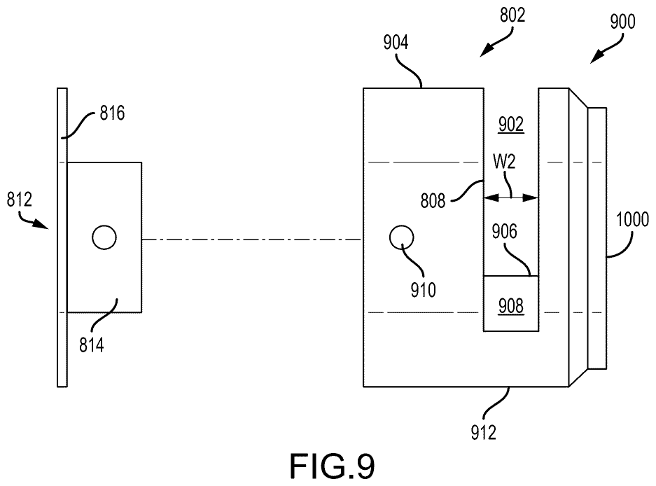

In various embodiments, a contiguous sidewall 806 and an interior end wall 808 of the housing body 802 define an interior volume 810 within the housing body 802. The interior volume 810 of housing body 802 may be enclosed by a faceplate 812. In various embodiments, faceplate 812 includes faceplate brackets 814 extending orthogonally from an interior face 816 (shown in FIG. 9) of the faceplate 812. In various embodiments, in response to coupling the faceplate 812 to the housing body 802, the faceplate brackets 814 are disposed within the interior volume 810 and contacted with an interior surface of the sidewall 806. In various embodiments, the ratio of the depth (i.e. as measured from the respective faceplate to mounting face) of the primary enclosure assembly 200 to the secondary enclosure assembly 800 may be between 1:1 and 1:2.

In various embodiments and with additional reference to FIG. 9, a mounting foot portion 900 of the housing body 802 is illustrated. Mounting foot portion 900 may be defined by a channel 902 cut relatively into the upper sidewall 904 of the housing body 802. The channel 902 may extend along the full length of the housing body 802 and be proximate the interior end wall 808 of the housing. The mounting foot portion 900 is proximate the channel 902 and, in this regard, the width ‘W2’ of the channel 902 is defined between the interior end wall 808 of the housing body 802 and the mounting foot portion 900.

In various embodiments, the channel 902 is sized to slip over an edge (for example, first edge 106) of the protective panel 102 so that a portion of the edge of the protective panel 102 is enclosed within the channel 902. The channel 902 extends into the width of the housing body 802 from the upper sidewall 904 of the housing body 802 relatively downward toward the lower sidewall 912 with the base 906 of the channel 902 disposed between one half and two thirds of the distance between the lower sidewall 912 to the upper sidewall 904. In this regard, the orientation of the channel 902 of the mounting foot portion 900 of the secondary enclosure assembly 800 is inverse from the orientation of the channel 402 of the mounting foot portion 400 of the primary enclosure assembly 200 thereby enabling protective panel 102 to be retained by the primary enclosure assembly 200 and the secondary enclosure assembly 800 when inserted within the respective channels (402, 902). In various embodiments, the ends of the channel base 406 curve inward from the sidewall 806. In this regard, the curved ends 908 of the channel may tend to facilitate case of mechanical interface with the protective panel 102 by slidably engaging with the protective panel 102 edge (e.g., first edge 106) to direct the panel edge into the channel 402. In various embodiments, the sidewall 806 may include a coupling feature 910 to facilitate coupling the faceplate 812 to the housing body 802. In various embodiments, the coupling feature 910 may include a locking mechanism to secure the faceplate 812 to the housing body 802.

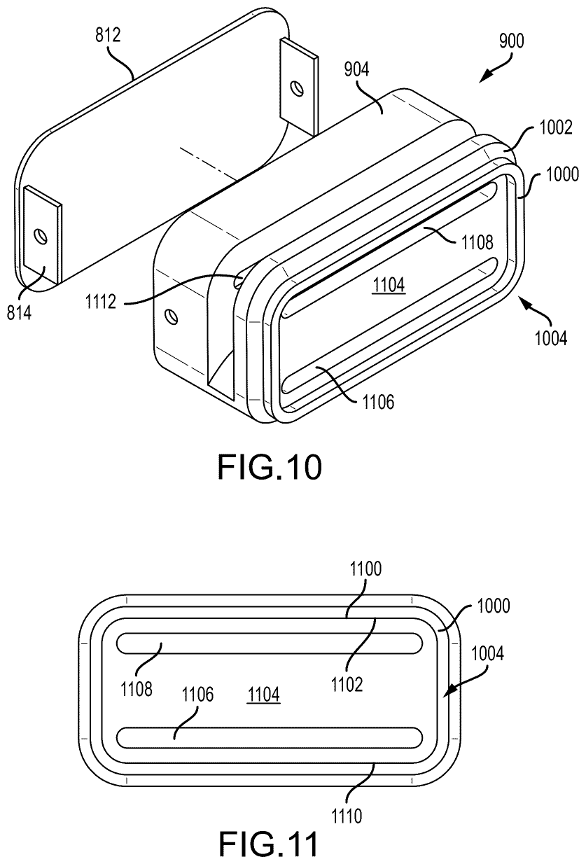

In various embodiments and with additional reference to FIGS. 10 and 11, the mounting foot portion 900 defines a mounting face 1000. The mounting face 1000 is distal of the channel 902 and interior end wall 808, and, when the interior volume 810 is enclosed, distal of the faceplate 812. In various embodiments, the mounting face 1000 may be rebated from the outer diameter of the mounting foot portion via a rebating feature 1002 such as a chamfer, fillet, or step. The secondary enclosure assembly 800 differs from the primary enclosure assembly 200 in that the mounting face 1000 comprises only one recessed socket portion 1004.

The recessed socket portion 1004 includes a socket face 1104 configured to interface with the wall bracket assembly described further herein. In various embodiments, a portion of the upper edge 1100 of the recessed socket portion 1004 is undercut along the plane of the socket face 1104 to form a groove 1102. In this regard, the groove 1102 extends relatively upward from the upper edge 1100 into the mounting foot portion 900. The groove 1102 is configured to retain a tab of the wall bracket assembly. In response to inserting the tab of the wall bracket assembly into the groove 1102 of the recessed socket portion 1104, an interference is generated which inhibits axial or vertical separation of the wall bracket assembly from the secondary enclosure 800 but enables lateral translation of the secondary enclosure 800 with respect to the wall bracket assembly (i.e., the wall bracket assembly may slidably engaged at the socket face 1104 such that the wall bracket assembly slides at the socket face 1104 along the long axis of the secondary enclosure 800).

In various embodiments, a first mounting feature 1106 and a second mounting feature 1108 arc formed into the socket face 1104. The first mounting feature 1106 may comprise a longitudinal slot cut into the socket face 1104 proximate the lower edge 1110. The first mounting feature 1106 may extend through the full thickness of the mounting foot portion 900 and directly through the interior end wall 808 into the interior volume 810 of the housing body 802.

The second mounting feature 1108 may comprise a longitudinal slot cut into the socket face 1104 proximate the upper edge 1100 of the recessed socket portion 1004. The second mounting feature 1108 is cut through the full thickness of the mounting foot portion 900 and opens into the channel 902. The cut of the second mounting feature 1108 is continued through the channel 902 (i.e., across the width W of the channel 902 gap) to a matching cutout 1112 (see FIG. 10) through the interior end wall 808 and into the interior volume 810 of the housing body 802. In various embodiments, in response to inserting the first edge 106 of the protective panel 102 into the channel 902, the longitudinal coupling feature 104 of the first edge 106 is aligned with the matching cutout 1112 and the second mounting feature 1108.

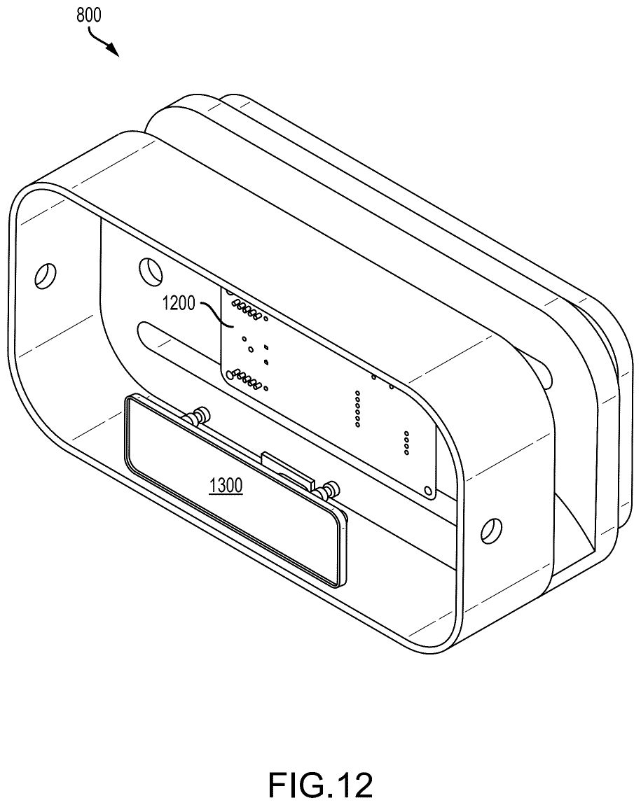

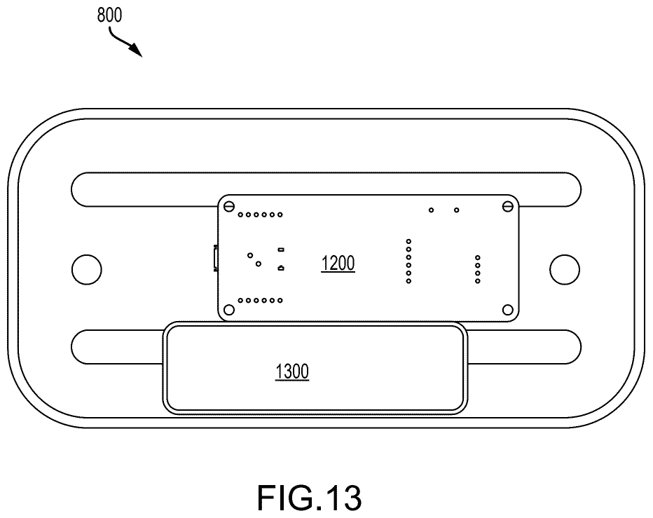

With additional reference to FIGS. 12 and 13, the secondary enclosure assembly 800 is illustrated with faceplate 300 rendered transparent. FIG. 12 shows the secondary enclosure assembly in perspective view and FIG. 13 shows a view directly into the interior volume 810 of the secondary enclosure assembly 800. In various embodiments, a plurality of electronic components May 1200 be mounted within the secondary enclosure assembly 800 in like regard to the primary enclosure assembly 200. In various embodiments, secondary enclosure assembly may include electronic components 1300, which may be mounted in and form a part of the faceplate 812. In various embodiments, the electronic components 1200 and 1300 may include any of the components and modules discussed above with respect to the primary enclosure assembly 200. In various embodiments, the electronic components of the primary enclosure assembly 200 and the second enclosure assembly 800 may be in electronic communication (e.g., via ethernet, NFC, or wireless network protocols such as 802.11, BLUETOOTH® and/or the like).

In various embodiments and with additional reference to FIG. 14, a wall bracket assembly 1400 of the smart bracket system 100 is illustrated in perspective view with transparency to show details of certain features. The mounter bracket assembly 1400 may comprise a wall interface plate 1500, a standoff plate 1600, and an enclosure interface plate 1700. The wall interface plate 1500 and the enclosure interface plate 1700 are coupled together by the standoff plate 1600. Each of the wall interface plate 1500, the standoff plate 1600, and the enclosure interface plate 1700 are substantially rectilinear. In response to coupling the standoff plate 1600 between the wall interface plate 1500 and the enclosure interface plate 1700, the long axis 1402 of the enclosure interface plate 1700 and the long axis 1404 of the wall interface plate 1500 are disposed orthogonally to each other when viewed along the long axis 1406 of the of the standoff plate 1404.

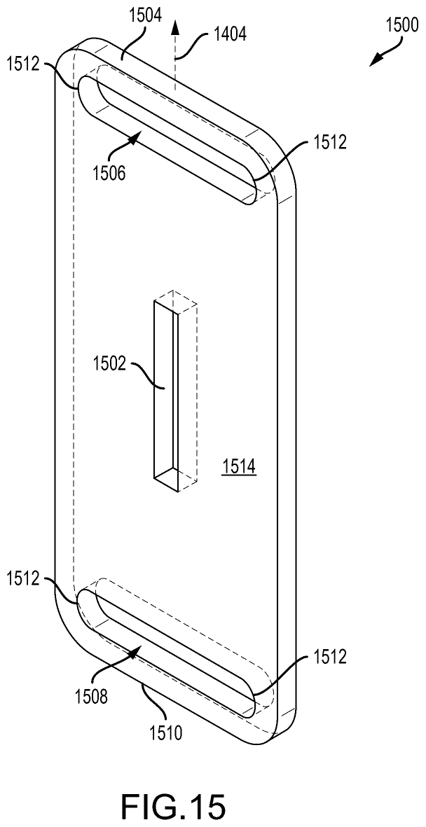

With additional reference to FIG. 15 the wall interface plate 1500 is illustrated in accordance with various embodiments. The wall interface plate 1500 may have a rectilinear body 1514 having rounded corners and a material thickness of about 0.25 in (6.35 mm) where about in this context means±0.01 in (0.25 mm). A mortice 1502 is cut at the center of the wall interface plate and extends primarily along the long axis 1404 of the wall interface plate. In various embodiments, the wall interface plate 1500 mortice 1502 is at least 5 times as long as it is wide. Proximate an upper edge 1504 of the wall interface plate, first slot 1506 is cut through the thickness of the wall interface plate material. A second slot 1508 is cut distal of the first slot 1506 and proximate the lower edge 1510 of the wall interface plate 1500. The first and second slots (1506, 1508) are each sized to admit the shank of a fastener such as a nail, a bolt, a screw, and/or the like. The ends 1512 of each of the slots may be rounded or radiused for strain relief of the plate material and to further assist in admitting the shank of a fastener.

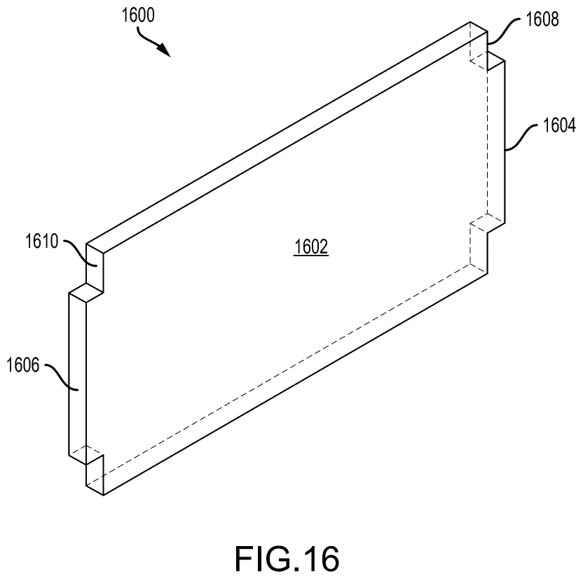

With reference to FIG. 16, standoff plate 1600 is illustrated in accordance with various embodiments. The standoff plate 1600 may comprise a rectilinear body 1602 having a long axis of sufficient length to enable a wall mounted flat panel display to rest relatively between the wall and the protective panel 102 when system 100 is assembled. The standoff plate 1600 may have a body 1602 thickness of about 0.25 in (6.35 mm) where about in this context means±0.01 in (0.25 mm). The rectilinear body 1602 may include a first tenon 1604 and a second tenon 1606. The first tenon 1604 may extend at a first edge 1608 of the body 1602 and the second tenon 1606 may extend at a second edge 1610 of the body 1602, distal of the first edge 1608. In various embodiments, the length to width ratio of the standoff plate 1600 may be between 2:1 and 3:1. The first tenon 1604 may be sized to fit within the mortice 1502 of the wall interface plate 1500. In like regard, the second tenon 1606 may be sided to fit within a corresponding mortice of an enclosure interface plate 1700. In various embodiments, each of the first and second tenon (1604, 1606) are centered along their respective edge (1608, 1610) of the body 1602.

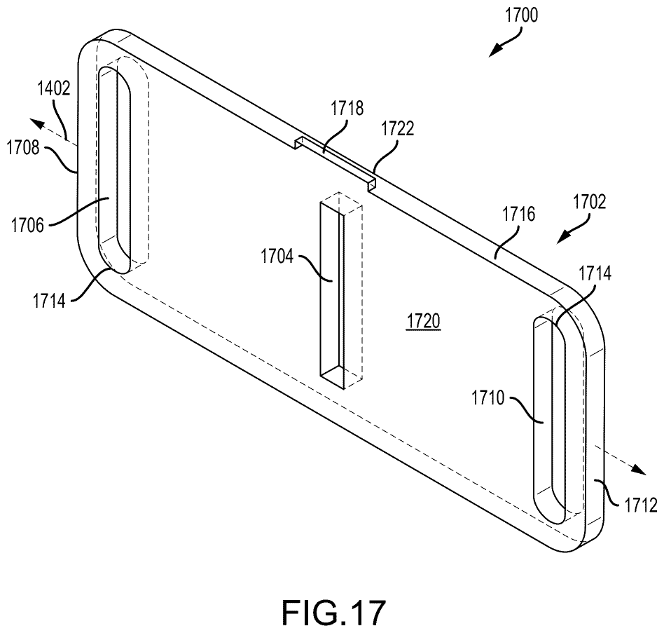

In various embodiments, and with additional reference to FIG. 17, enclosure interface plate 1700 is illustrated. The enclosure interface plate 1700 comprises a rectilinear body 1702 having rounded corners and may have a material thickness of about 0.25 in (6.35 mm) where about in this context means±0.01 in (0.25 mm). A mortice 1704 is cut at the center of the enclosure interface plate 1700 and extends along the short axis (i.e. orthogonal to the long axis 1402) of the enclosure interface plate 1700. A first slot 1706 is positioned proximate and relatively inward of a first short edge 1708 of the body 1702. A second slot 1710 is positioned distal of the first slot 1706 proximate and relatively inward of a second short edge 1712 of the body 1702. Each of the first slot 1706 and second slot 1710 are cut through the full thickness of the body 1702. Each of the slots (1706, 1710) run along the respective edge (1708, 1710) orthogonal to the long axis 1402.

The slots (1706, 1710) are sized to admit the shank of a fastener such as a nail, a bolt, a screw, and/or the like. In various embodiments, the ends 1714 of each of the slots (1706, 1710) may be rounded or radiused for strain relief of the plate material and to further assist in admitting the shank of a fastener. At an upper edge 1716 of the body 1702, and centered relatively above the enclosure interface plate 1700 mortice 1704, a tab 1718 extends relatively outward of the upper edge 1716. In various embodiments, the tab 1718 does not extend from the full thickness of the enclosure interface plate body 1702 at the upper edge 1716. For example, in contrast to the thickness of the plate, the tab may only be about 0.984 in (2.54 mm) thick where about in this context means±±0.01 in (0.25 mm). In various embodiments, tab 1718 is configured to interface with a groove such as 602 of the primary enclosure assembly 200. For example, tab 1718 may extend from the upper edge 1716 flush with mating surface 1720 of the body 1702 leaving a portion 1722 of the upper edge 1716 exposed and surrounding the tab 1718. In this regard, in response to inserting the tab 1718 into the groove of the primary housing assembly 200 or secondary housing assembly 800, an interference is generated which holds mating surface 1720 in contact with the socket face (e.g., 604) of the mounting foot portion (e.g. mounting foot portion 400) of the housing assembly (e.g. primary housing assembly 200).

In various embodiments, the component elements of smart bracket system 100 may be provided to an end user in kit form for assembly by the end user to enable the benefits of protection to wall mounted flat panel displays. The kit may include assembly instructions for the smart bracket system 100. The kit may include a plurality of fasteners suitable for coupling the various components of system 100. The components of system 100 are designed to be economical of manufacture and case of assembly with common tools. By the assembly of the provided components, the user can elect to protect a wide range of wall-mounted flat panel displays. Kit components are designed to be used in as many of the different configurations as possible.

The user may locate corners of the flat panel display and secure one or more wall bracket assemblies 1400 to the wall proximate the corners and/or along the upper and lower edgers of the flat panel display by inserting fasteners through the appropriate slots of the wall interface plate 1500 of the wall bracket assemblies 1400. Normally it is useful to locate studs within the wall to ensure that connections between the wall and the wall bracket assemblies 1400 are strong enough to support the weight of the enclosure assemblies (200, 800) and the protective panel 102, however wall anchors may also be used. System 100 accommodates both standard and non-standard stud spacing because the wall interface plate 1500 of the wall bracket assemblies 1400 incorporate slots allowing for fasteners to be offset. Standard and non-standard stud spacings are further accommodated because, as described further herein, each of the enclosure assemblies (200, 800) are translatable laterally with respect to the wall bracket assemblies 1400. For example, the user may couple two wall bracket assemblies near the upper edge of the wall mounted flat panel display (i.e., the upper wall bracket assemblies) and proximate the corners of the wall mounted flat panel display and may couple two additional wall bracket assemblies (i.e., the lower wall bracket assemblies) near the lower edge of the wall mounted flat panel and proximate the corners thereof.

After the wall bracket assemblies 1400 are securely mounted to the wall, the primary enclosure assembly 200 is hung from the upper wall bracket assemblies by inserting the tab 1718 of the corresponding wall bracket assembly 1400 into the groove 602 of the primary enclosure assembly 200 and subsequently coupling thereto. In like regard, secondary enclosure assemblies 800 are hung from each of the lower wall bracket assemblies 1400 by inserting tab 1718 of the corresponding wall bracket assembly 1400 into the corresponding groove 1102 and subsequently coupling thereto. It will be appreciated that the user may use any number of primary enclosure assemblies, secondary enclosure assemblies, and combination of wall bracket assemblies sufficient to support the protective panel 102. The user may align the enclosure assemblies (200, 800) relative to each other by sliding them (as described further herein) relative to the wall bracket assemblies 1400. The user may then insert the protective panel 102 into the corresponding channels (402, 902) of the enclosure assemblies (200, 800) thereby disposing the flat panel display between the protective panel 102 and the wall. In various embodiments, at least two secondary enclosure assemblies are used to support the lower edge (i.e. first edge 106) of the protective panel 102. Fasteners may be inserted through the appropriate mounting features of the enclosure assemblies (200, 800) to couple the enclosure assemblies (200, 800) to the corresponding enclosure interface plates 1700 of the wall bracket assemblies 1400. For example, fasteners may be inserted into the interior volume 210 of the primary enclosure assembly, through first mounting feature 606 and mounting foot portion 400, and through each of the slots (1706, 1710) of an enclosure interface plate 1700 of a wall bracket assembly 1400. In like regard, fasteners may be inserted into the interior volume 210 of the primary enclosure assembly, through second mounting feature 608, into the channel 402 and through a longitudinal coupling feature 104 of the protective panel 102, through the mounting foot portion 400, and through each of the slots (1706, 1710) of the enclosure interface plate 1700 of the wall bracket assembly 1400 thereby coupling the protective panel 102 to the primary enclosure assembly 200 and further coupling the primary enclosure assembly 200 to the wall bracket assembly 1400.

The system and kit as described has advantages for the consumer and the retailer. For the retailer, stocking the kit avoids having to stock multiple disparate kits, avoids creating a customer service burden and helps the consumer select the right kit, and avoids restocking costs when kits are returned. For the consumer the kit satisfies the mounting requirements for a protective panel for virtually any flat panel display or set of electronic components that the consumer might use it with. The kit incorporates multi-purpose components to reduce the parts count. Many components may be broken down or nested for shipping and storage in the minimum space. Wall mounting is accomplished with minimum need to “work behind” the components because the enclosure assemblies (200, 800) are internally accessible via removable faceplates.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112 (f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

In various embodiments, components, modules, and/or engines of the system may be implemented as micro-applications or micro-apps. Micro-apps are typically deployed in the context of a mobile operating system, including for example, a WINDOWS® mobile operating system, an ANDROID® operating system, an APPLE® iOS operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM®, Inc. (Armonk, NY) is an example of a commercially available middleware product. An Enterprise Service Bus (“ESB”) application is another example of middleware

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE CHROME™ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

The disclosure and claims do not describe only a particular outcome of a system for failure detection tools, but the disclosure and claims include specific rules for implementing the outcome of a system for failure detection tools and that render information into a specific format that is then used and applied to create the desired results of a system for failure detection tools, as set forth in McRO, Inc. v. Bandai Namco Games America Inc. (Fed. Cir. case number 15-1080 Sep. 13, 2016). In other words, the outcome of a system for failure detection tools can be performed by many different types of rules and combinations of rules, and this disclosure includes various embodiments with specific rules. While the absence of complete preemption may not guarantee that a claim is eligible, the disclosure does not sufficiently preempt the field of a system for failure detection tools at all. The disclosure acts to narrow, confine, and otherwise tie down the disclosure so as not to cover the general abstract idea of just a system for failure detection tools. Significantly, other systems and methods exist for a system for failure detection tools, so it would be inappropriate to assert that the claimed invention preempts the field or monopolizes the basic tools of a system for failure detection tools. In other words, the disclosure will not prevent others from a system for failure detection tools, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

What is claimed is:

1. A smart bracket system for wall mounted flat panel displays, comprising:
a primary enclosure assembly having a removable faceplate, a rectilinear housing body with a contiguous sidewall and an end wall defining an interior volume of the primary enclosure assembly, a channel proximate the end wall and extending into the width of the housing body relatively upward from a lower sidewall toward an upper sidewall of the housing body of the primary enclosure assembly, and a mounting foot portion having a first recessed socket portion and a second recessed socket portion;
a secondary enclosure assembly having a removable faceplate, a rectilinear housing body with a contiguous sidewall and an end wall defining an interior volume of the secondary enclosure assembly, a channel proximate the end wall and extending into the width of the housing body relatively downward from an upper sidewall toward a lower sidewall of the housing body of the secondary enclosure assembly, and a mounting foot portion having a third recessed socket portion;
a rectilinear protective panel having a first longitudinal coupling feature and a second longitudinal coupling feature, wherein the first longitudinal coupling feature and the second longitudinal coupling feature are located proximate opposite edges of the protective panel; and
a plurality of wall bracket assemblies, wherein each of the plurality of wall bracket assemblies comprises a wall interface plate, an enclosure interface plate, and a standoff plate coupled between the wall interface plate and the enclosure interface plate.

2. The system of claim 1, wherein a portion of the sidewall of the primary enclosure assembly comprises an orderly row of a plurality of perforations through the sidewall and into the interior volume of the housing body of the primary enclosure assembly enabling fluid communication therebetween.

2. The system of claim 2, wherein a mounting face of the mounting foot portion of the primary enclosure assembly includes a wiring cutout.

3. The system of claim 1, wherein the protective panel is slidably engageable with the channel in the housing body of the primary enclosure assembly and the channel of the housing body of the secondary enclosure assembly.

4. The system of claim 1, wherein the long axis of the enclosure interface plate and the long axis of the wall interface plate are disposed orthogonally to each other when viewed along the long axis of the of the standoff plate.

5. The system of claim 1, wherein each of the first recessed socket portion and the second recessed socket portion comprises a socket face, and wherein a portion of an upper edge of each of the first recessed socket portion and the second recessed socket portion of the primary enclosure assembly is undercut along the plane of the respective socket face to form a corresponding groove.

6. The system of claim 5, wherein each enclosure interface plate comprises a tab extending relatively outward of an upper edge of the enclosure interface plate and configured to interface with the groove of the first recessed socket portion and the groove of the second recessed socket portion.

7. The system of claim 1, wherein at least one electronic component is disposed within the interior volume of the primary housing assembly.

8. The system of claim 7, wherein the primary enclosure assembly includes a DIN rail within the interior volume, and wherein the at least one electronic component is coupled to the DIN rail.

9. A flat panel display protection kit for a wall mounted flat panel display, comprising:
a primary enclosure assembly having a removable faceplate, a rectilinear housing body with a contiguous sidewall and an end wall defining an interior volume of the primary enclosure assembly, a channel proximate the end wall and extending into the width of the housing body relatively upward from a lower sidewall toward an upper sidewall of the housing body of the primary enclosure assembly, and a mounting foot portion having a first recessed socket portion and a second recessed socket portion;
at least one secondary enclosure assembly, wherein each secondary enclosure assembly has a removable faceplate, a rectilinear housing body with a contiguous sidewall and an end wall defining an interior volume of the secondary enclosure assembly, a channel proximate the end wall and extending into the width of the housing body relatively downward from an upper sidewall toward a lower sidewall of the housing body of the secondary enclosure assembly, and a mounting foot portion having a third recessed socket portion;
a plurality of wall bracket assemblies, wherein each of the wall bracket assemblies comprises a wall interface plate, an enclosure interface plate, and a standoff plate coupled between the wall interface plate and the enclosure interface plate; and
a rectilinear protective panel having a first longitudinal coupling feature and a second longitudinal coupling feature, wherein the first longitudinal coupling feature and the second longitudinal coupling feature are located proximate opposite edges of the protective panel,
said kit being in a useful configuration wherein,
the primary enclosure assembly is coupled to the wall and proximate the wall mounted flat panel display,
wherein the primary enclosure assembly is coupled to the wall via at least one of the plurality of wall bracket assemblies at the first recessed socket portion and at least one of the plurality of wall bracket assemblies at the recessed socket portion, and
each of the at least one secondary enclosure assembly are coupled at their respective third recessed socket portion, via at least one of the plurality of wall bracket assemblies, to the wall and proximate the wall mounted flat panel display, and
wherein the rectilinear protective panel is inserted into and coupled within the channel of the housing body of the primary enclosure assembly and the channel of the housing body of each secondary enclosure assembly, thereby disposing the wall mounted flat panel display relatively between the protective panel and the wall.

10. The flat panel display protection kit of claim 9, wherein the plurality of wall bracket assemblies comprises at least four wall bracket assemblies and wherein the at least one secondary enclosure assembly comprises at least two secondary enclosure assemblies.

11. The flat panel display protection kit of claim 9, further comprising a plurality of fasteners.

12. The flat panel display protection kit of claim 9, further comprising a set of assembly instructions.

13. The flat panel display protection kit of claim 9, wherein a portion of the sidewall of the primary enclosure assembly comprises an orderly row of a plurality of perforations through the sidewall and into the interior volume of the housing body of the primary enclosure assembly enabling fluid communication therebetween.

14. The flat panel display protection kit of claim 13, wherein a mounting face of the mounting foot portion of the primary enclosure assembly includes a wiring cutout.

15. The flat panel display protection kit of claim 9, further comprising at least one electronic component disposed within the interior volume of the primary housing assembly.

16. The flat panel display protection kit of claim 9, wherein the housing body of the primary enclosure assembly has a length to width ratio of between 3:1 and 14:1.

17. The flat panel display protection kit of claim 9, wherein the housing body of each of the at least one secondary enclosure assembly has a length to width ratio of between 1:1 and 4:1.
